(19) United States
(12) Patent Application Publication
(10) Pub. No.: US 2004/0034579 A1
(43) Pub. Date: Feb. 19, 2004

(54) Combining the internet and bar code technologies, using random identification numbers to prevent counterfeit products

(76) Inventors: Jerry Zhi Xu, Framingham, MA (US); Wei Kuo, Flushing, NY (US); Biansheng Xu, Flushing, NY (US)

Correspondence Address: Wei Kuo, 153-38 77th Rd., Kew Gardens Hill, NY, 11367, US

(21) Appl. No.: 10/223,132

(22) Filed: Aug. 19, 2002

(51) Int. Cl. G06F 17/60; B42D 15/00

(52) U.S. Cl. 705/28; 283/67

(57) ABSTRACT

A method to prevent the sale of counterfeit products has been developed by utilizing the bar code technology and the World Wide Web to give each individual merchandise its unique identification number and be able to verify this number against a database online.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

In today's market, there is a need for an effective method to recognize a counterfeit product. Without such method, counterfeit products are free to fill the market, costing the government and manufacturers great effort and resources to try to prevent them with little success. These counterfeit products bring profits to those who make them illegally, but losses to the customers who brought them, thus hinder economic development.

### BRIEF SUMMARY OF THE INVENTION

This invention takes advantage of the popularity of the internet and the maturity of the bar code technology, gives each product its unique identification number, thus preventing the sale of counterfeit products. Customers can verify the validity of the products by verifying its bar code over the internet at any time and place. This invention serves to protect both the manufacturers and the customers.

### BRIEF DESCRIPTION OF THE SEVERAL VIEWS OF THE DRAWING

Not Applicable

### DETAILED DESCRIPTION OF THE INVENTION

Each product is given a unique ID in the form of a bar code. Every bar code consists of two parts. The first part is the manufacturing date. The second part is a unique identification number for each product. Each number is a twelve digit number formed by putting six two digit numbers together. Each of these six numbers is a digit between and including, 01 and 99. For each product, six numbers will be chosen from this set at random. This twelve digit number and the manufacturing date will form a unique bar code for each product. The bar codes are products are covered with a protective layer that can be scratched away to reveal the bar code. This ensures that each bar code can be verified only once.

All of the ID numbers are stored in a database. A web site is built on the World Wide Web, and it is the only way to access this database. When a customer is interested in purchasing a product, the salesperson will scratch away the protective surface covering the ID number and scan the bar code into the web site. The web site contains software that compares the number to each in its database, if it finds a match, a positive response will be give, otherwise, a negative one. Only when a positive response is given will the sale go through, otherwise, the customer has the right to refuse to purchase. This requires the stores to have access to the WWW, which should be achievable since this invention is mainly aimed at protecting name-brand and expensive products.

The web site will need to be protected to be officially recognized by the customers. It can take one of two forms, as part of the official web site of the manufacturer of the product, or as an official web site registered with the government that all products are checked against.

To ensure that used ID number are not reproduced into bar codes and put on counterfeit products, an ID number can be used only once. If a number is submitted to the web site for verification, and a positive response is given, this number will be erased from the database shortly. The protective cover over the bar code also serves this purpose. Customers have the right to refuse to purchase a product with its cover scratched away previously.

For some products, it is important for them to be used within a time limit. This invention can also be used to ensure no product is sold after its expiration date. The ID numbers in the database can carry expiration dates, upon which the expired numbers will be erased to protect the customers. This is especially important for products like food and medicine.

This invention can also be used by the manufacturers for promotional purposes. They can attach prizes to certain ID numbers to attract purchase of these products. When an ID containing a prize is submitted, the web site will notify the customer that he/she has won a prize from the manufacturer. This provides an efficient and useful way to promote a product.

What is claimed is:

1. A method of recognizing a counterfeit product comprising the steps of: putting a unique identification number in a form of a bar code on every product, storing these identification numbers in a database on the World Wide Web, and scanning these bar codes to match them against the database for validation at the time of the sales.

2. The method as claimed in claim 1, further comprising the steps of choosing six two digit numbers from the set 01-99 at random, and putting these six numbers together to form a twelve digit identification number.

3. The method as claimed in claim 1, wherein the bar code on each product is covered with a protective layer, which can be scratched away at the time of validation.

4. The method as claimed in claim 1, wherein each identification number in a dataset that has been positively matched against the bar code on a product is erased to prevent reuse.

5. The method as claimed in claim 1, further comprising erasing identification numbers in the database that belong to products past their expiration dates to prevent their sales.

6. The method as claimed in claim 1, further comprising using these identification numbers for promotional purposes where as a bar code that is linked to a prize is submitted to the database for validation, the customer will receive instant notification of the winning.
